(19) United States
(12) Patent Application Publication
(10) Pub. No.: US 2002/0111131 A1
(43) Pub. Date: Aug. 15, 2002

(54) Air vent for vehicles

(75) Inventor: Michael Demerath, Huffler (DE)

Correspondence Address: TAROLLI, SUNDHEIM, COVELL,, TUMMINO & SZABO L.L.P., 1111 LEADER BUILDING, 526 SUPERIOR AVENUE, CLEVELAND, OH, 44114-1400, US

(73) Assignee: TRW Automotive Electronics & Components GmbH & Co. KG

(21) Appl. No.: 10/037,978

(22) Filed: Jan. 3, 2002

(30) Foreign Application Priority Data
Jan. 5, 2001 (DE) 201 00 157.8

(51) Int. Cl. B60H 1/24

(52) U.S. Cl. 454/162

(57) ABSTRACT

An air vent for vehicles has a grid structure that is made of electrically conductive plastic components and that provides an electromagnetic shielding effect. The air vent can have a frame that surrounds the grid structure and that can be installed in an opening of a car body.

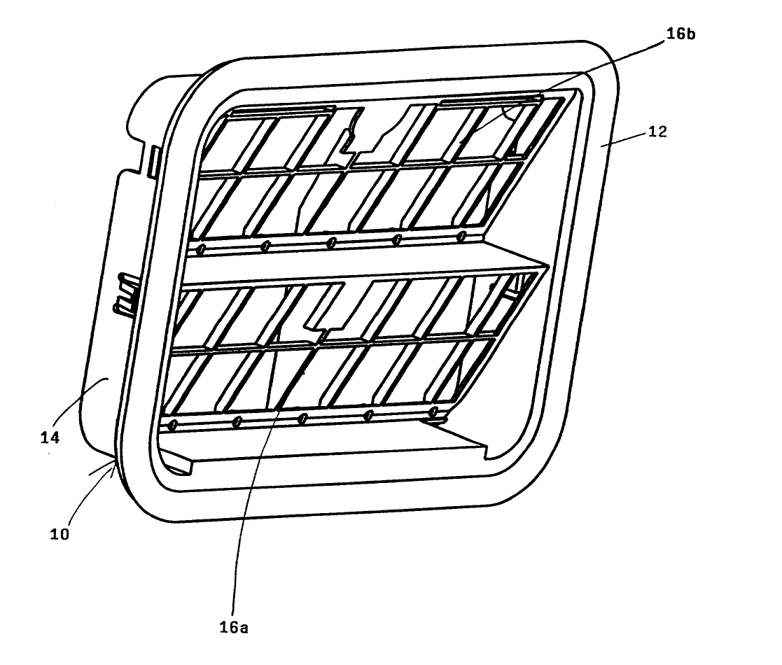

### FIELD OF THE INVENTION

The present invention relates to an air vent for vehicles.

### BACKGROUND OF THE INVENTION

In modern vehicles, air vents that are installed in the car body are made of plastics since this reduces the weight and saves costs in comparison to metal versions. If an antenna is situated in front of the air vent on the outside of the car body, it might be necessary to shield against electromagnetic radiation, since the car body is interrupted in the area of the air vent that is made of plastics, the electromagnetic shielding action is achieved by using an additional metal grid. The metal grid that has to be additionally provided increases the material and assembly work.

### SUMMARY OF THE INVENTION

The present invention provides an air vent for vehicles that has the advantages of a plastic version and, at the same time, has electromagnetic shielding properties.

The air vent according to the invention for vehicles has a grid structure made of electrically conductive plastic components that provides an electromagnetic shielding action Due to the electrical conductivity of the plastic components of which the grid structure is made, the electromagnetic shielding function is already ensured. The plastic components can be rendered electrically conductive in many ways. Within the scope of the invention, the following advantageous embodiments are provided, which can be used individually or in combination:

the plastic components are rendered conductive by admixing electrically conductive particles into a plastic material;

the plastic components are made by backing a metal film with a plastic material;

the plastic components are rendered conductive by means of a metallic coating;

the plastic components have a metal layer applied externally thereon;

the plastic components have a galvanically applied metallic coating;

the grid structure is formed by a metal grid embedded in a plastic material by injection-molding.

Preferably, the air vent also has a frame that surrounds the grid structure and that is adapted to be installed in an opening in the car body. Alternatively, the air vent forms an integral part of the car body.

### BRIEF DESCRIPTION OF THE DRAWING

The invention is now explained in greater detail with reference to an embodiment. The single figure of the appended drawing shows a perspective view of an air vent that is adapted to be installed in an opening in the car body.

### DESCRIPTION OF THE PREFERRED EMBODIMENTS

The air vent has a generally rectangular frame that is latched into a matching opening in the car body. This frame, generally designated with the reference numeral 10, consists of a flange 12 which is intended to abut against the outer surface of the car body and, following the flange, of a channel wall 14 in which a double grid structure 16a, 16b is attached which spans the free opening of the channel 14. This grid structure 16a, 16b consists of plastic components that are electrically conductive. Due to the electric conductivity of these plastic components which make up the grid structure 16a, 16b, the latter provides an electromagnetic shielding action that closes the gap left in the car body.

The electrical conductivity of the plastic components that make up the grid structure 16a, 16b is created in an advantageous embodiment of the invention in that electrically conductive particles are admixed into the plastic material.

According to another embodiment, the grid structure 16a, 16b is formed by a metal grid embedded in a plastic material by injection-molding.

Additional embodiments within the scope of the invention are:

the plastic components of the grid structure 16a, 16b are made by backing a metal film with a plastic material;

the plastic components of the grid structure 16a, 16b are rendered conductive by means of a metallic coating;

the grid structure 16a, 16b made of plastics is rendered electrically conductive by means of a metal layer applied externally thereon;

the grid structure 16a, 16b made of plastics receives a galvanically applied metallic coating.

1. An air vent for vehicles, comprising a grid structure made of electrically conductive plastic components and providing an electromagnetic shielding action.

2. The air vent according to claim 1, comprising a frame that surrounds said grid structure and is adapted to be installed in an opening in a car body.

3. The air vent according to claim 1, and forming an integral part of a car body.

4. The air vent according to claim 1, wherein said plastic components are rendered conductive by admixing electrically conductive particles into a plastic material.

5. The air vent according to claim 1, wherein said plastic components are rendered conductive by backing a metal film with a plastic material.

6. The air vent according to claim 1, wherein said plastic components are rendered conductive by means of a metallic coating.

7. The air vent according to claim 1, wherein said plastic components have a metal layer applied externally thereon.

8. The air vent according to claim 1, wherein said plastic components have a galvanically applied metallic coating.

9. The air vent according to claim 1, wherein said grid structure is formed by a metal grid embedded in a plastic material by injection-molding.
